(19) United States
(12) Patent Application Publication
(10) Pub. No.: US 2016/0356261 A1
(43) Pub. Date: Dec. 8, 2016

(54) OCEAN CURRENT POWER GENERATION SYSTEM

(71) Applicant: GHING-HSIN DIEN, Taipei City (TW)

(72) Inventor: GHING-HSIN DIEN, Taipei City (TW)

(21) Appl. No.: 15/172,153

(22) Filed: Jun. 3, 2016

(30) Foreign Application Priority Data
Jun. 5, 2015 (TW) 104118274

(51) Int. Cl. F03B 13/08; E02B 9/08; F03B 13/14

(52) U.S. Cl. CPC F03B 13/08; F03B 13/141; E02B 9/08

(57) ABSTRACT

An ocean current power generation system which uses an inlet pipe to guide the ocean current to a pool at the sea surface for power generation, the ocean current's kinetic energy is transformed into potential energy when the water flows into the pool and stored therein, an outlet pipe or path drains the stored water back to the sea and a generator or turbine is installed at the drainage path to generate electric power.

### CROSS REFERENCE TO RELATED APPLICATIONS

This Non-provisional application claims priority under 35 U.S.C. §119(a) on Patent Application No(s). 104118274 filed in Taiwan, Republic of China on Jun. 5, 2015, the entire contents of which are hereby incorporated by reference.

### BACKGROUND OF THE INVENTION

### Field of Invention

The present invention relates to an ocean current power generation system.

### Related Art

Generally the present ocean current power generation systems use undersea turbine generators with blades to collect the ocean current's kinetic energy to generate electric power, and transmit the electric power to land with undersea power cables. The undersea turbine generators must be water-proof and connected to the power cables under the sea. As one can imagine, the undersea turbine generators must resist against high water pressure, strong ocean current and the corrosion of salt water, so it is expensive to build and difficult to maintain. The rotating blades also cause impacts to fishing fields. Fishing boats must keep their fishing nets or wires from being tangled with the blades of the undersea turbine generators. Also, the undersea power cables and turbine generators generate magnetic field interferences to marine creatures. Based on the limitations of costs and technologies, the ocean current power generator system is mostly still under development.

Therefore, in order to make the ocean current power generation more available, it is an important subject to provide a low cost system that uses low cost generators and is easy to maintain, and most importantly, is friendly to the environment.

### SUMMARY OF THE INVENTION

In view of the foregoing, an objective of the present invention is to provide an ocean current power generation system that does not use undersea turbine generators and can be built with lower costs and requires lower maintenance fees. Another objective of the present invention is to provide an ocean current power generation system that has little impact to the traditional fishing field and does not generate magnetic field interferences to marine creatures.

To achieve the above objectives, the present invention discloses an ocean current power generation system. The ocean current power generation system comprises an inlet pipe, a water pool, an outlet pipe (or path) and a generator. The inlet pipe has at least one inlet disposed near the ocean current to collect the water flow, and guides the water to flow up to the sea level. The water pool is disposed at the sea level and connected to the output of the inlet pipe. The inflow water from the inlet pipe is stored in the water pool. The water level stored in the water pool is higher than the sea level. The outlet pipe (or path) is connected to the water pool and has an outlet to the sea. The water in the water pool is drained back to the sea through the outlet pipe or path. The generator is disposed at the drainage path of the outlet pipe or path, and uses the draining water flow to generate electric power.

In one embodiment of the present invention, the water pool is disposed at the shore.

In one embodiment of the present invention, the water pool is disposed at the surface of the sea, and is fixed by a supporting frame or anchored to the seabed.

As mentioned above, the ocean current power generation system of the invention does not need undersea generators (turbines), the major parts under the sea is the inlet pipes and the outlet pipes (or paths) which do not require constant maintenance and have a long life time. The power cables and generators can be placed onshore and do not need to resist the high water pressure and salt-water corrosion. Accordingly, the goal of reduced system costs and maintenance fees are achieved. Also, there are no magnetic field interferences to marine creatures and the impact to the traditional fishing field is little.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a system diagram showing an ocean current power generation system according to a first embodiment of the invention;

FIG. 2 is a system diagram showing an ocean current power generation system according to a second embodiment of the invention.

### DETAILED DESCRIPTION OF THE INVENTION

The present invention will be apparent from the following detailed description, which proceeds with reference to the accompanying drawings, wherein the same references refer to the same elements.

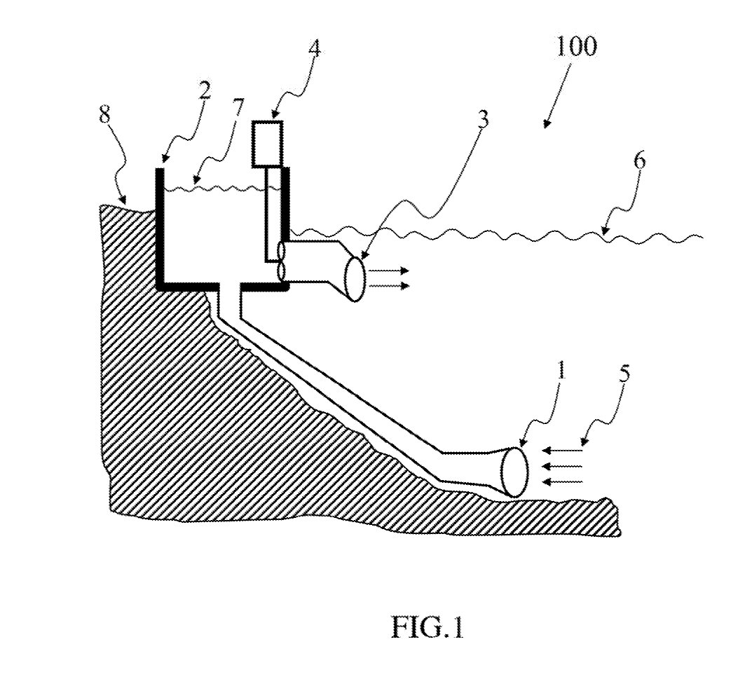

FIG. 1 is a system diagram of an ocean current power generation system according to a first embodiment of the invention.

Referring to FIG. 1, an ocean current power generation system 100 includes an inlet pipe 1, a water pool 2, an outlet pipe 3 and a generator 4. The inlet of the inlet pipe 1 is disposed near to the ocean current 5, the inlet pipe 1 collects and guides the ocean current 5 to flow to the water pool 2. The water pool 2 is installed near the shore 8 and stores the inflow water. The water level 7 of the water stored in the water pool 2 is higher than the sea level 6, and so the kinetic energy of the inflow water transforms into potential energy. The water stored in water pool 2 is drained back to the sea through the outlet pipe 3. The generator 4 is installed at the drainage path and uses the draining water flow to generate electric power. The outlet pipe 3 can be replaced by an open water path to the sea.

The ocean current power generation system 100 uses an inlet pipe 1 to guide the ocean current to flow to a water pool 2 at the sea surface and transforms kinetic energy of the ocean current into potential energy when the water is stored in the pool. The ocean current power generation system 100 uses an outlet pipe 3 (or path) connected to the sea to drain the stored water back to the sea and thus the potential energy of the water stored in the water pool 2 then transforms back to kinetic energy for the operation of the generator 4, and then such kinetic energy is transformed to electric power by the generator 4. In detail, as the ocean current is guided to the water pool 2 and stored in the pool, its kinetic energy is transformed into potential energy with the following formula:

½MV²=Mgh

Where M=mass of water, V=velocity of water, g=9.8 m/s², and h=the difference in height between the stored water level 7 and the sea level 6.

For example, an ocean current with a flowing speed of 3 meter per second will create an emerging water of 0.46 meter height above the sea level (if the friction loss in the pipe is ignored), so the stored water level in the pool will be higher than the sea level by 0.46 meter in height. When the water is drained back to the sea, the stored potential energy is transformed into kinetic energy and then electric power with a power generator.

To increase the water flowing speed in the inlet pipe 1, the inlet of the inlet pipe 1 can be enlarged (with concentrators or shrouds), or multiple inlets can be installed for one inlet pipe 1 to collect more ocean current. Because the ocean current is a large-area constant-speed water flow, so when an enlarged inlet or multiple inlets are pushed by the ocean current and the collected flowing water is concentrated and flows into the inlet pipe, the water flowing speed in the inlet pipe 1 can be effectively increased. Therefore, the inflow water speed of the water pool 2 is increased and so the draining outflow water speed can be increased, eventually the generated electric power can be increased.

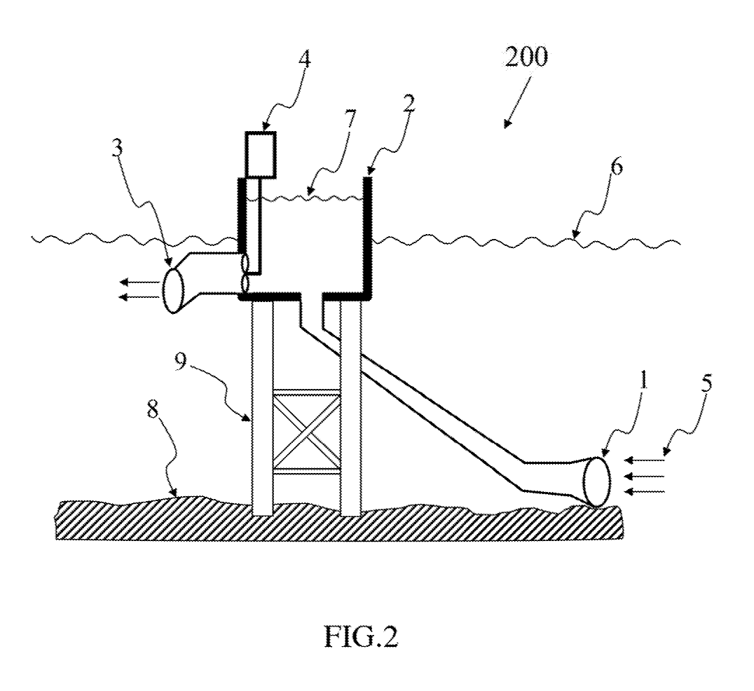

FIG. 2 is a system diagram of an ocean current power generation system according to a second embodiment of the invention.

Referring to FIG. 2, an ocean current power generation system 200 according to a second embodiment of the invention includes an inlet pipe 1, a water pool 2, an outlet pipe 3 and a generator 4. The ocean current power generation system 200 is substantially the same as the ocean current power generation system 100 at most parts. The ocean current power generation system 200 is different from the ocean current power generation system 100 in FIG. 1 as described as following. The water pool 2 in FIG. 2 is installed at the sea surface by the supporting frame 9 near the ocean current 5. Similar to their counterparts of the ocean current power generation system 100, the water level 7 of the water stored in the water pool 2 is higher than the sea level 6, the water in water pool 2 is drained back to the sea through the outlet pipe 3. The generator 4 is installed at the drainage path and uses the draining water flow to generate electric power. Although in FIG. 2 the supporting frame 9 is built on the ocean floor, it is possible that the water pool 2 is left floating on the sea and anchored to the seabed. The outlet pipe 3 can be replaced by an open water path to the sea.

In summary, the ocean current power generation system of the invention uses pipes to guide the water current to flow on to the sea level, transforms the kinetic energy to potential energy, and then into electric energy. The preferred embodiment does not use high cost undersea turbine generators, and has the advantage of lower system cost, longer life time and easier maintenance, and is more friendly to the environment.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An ocean current power generation system, comprising:
an inlet pipe has at least one inlet disposed near the ocean current to collect the water flow, and guide the water to flow up to the sea level;
a water pool disposed at the sea level and connected to the output of the inlet pipe, wherein the inflow water from the inlet pipe is stored in the water pool, and the water level stored in the water pool is higher than the sea level;
an outlet pipe or path connected to the water pool and has an outlet to the sea, wherein, the water in the water pool is drained back to the sea through the outlet pipe or path; and
a generator disposed at the drainage path of the outlet pipe or path, and uses the draining water flow to generate electric power.

2. The ocean current power generation system of claim 1, wherein the water pool is disposed at the shore.

3. The ocean current power generation system of claim 1, wherein the water pool is disposed at the surface of the sea, and is fixed by a supporting frame or anchored to the seabed.
